(19) United States
(12) Patent Application Publication
(10) Pub. No.: US 2009/0070419 A1
(43) Pub. Date: Mar. 12, 2009

(54) Administering Feeds Of Presence Information Of One Or More Presentities

(75) Inventors: Michael A. Gilfix, Austin, TX (US); Victor S. Moore, Lake City, FL (US); Rhys D. Ulerich, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/853,612

(22) Filed: Sep. 11, 2007

(51) Int. Cl. G06F 15/16

(52) U.S. Cl. 709/204

(57) ABSTRACT

Methods, apparatus, and products for administering feeds of presence information of one or more presentities including creating a feed definition; adding to the feed definition one or more identifications of presentities; receiving a feed request; creating the feed, the feed including presence information for presentities identified in the feed definition; and sending a response to the feed request including the feed.

### BACKGROUND OF THE INVENTION

1. Field of the Invention

The field of the invention is data processing, or, more specifically, methods, apparatus, and products for administering feeds of presence information of one or more presentities.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Current computer users often use one or more networked devices. The availability of a user to communicate through a network and any other contextual information about a user's activities while connected to the network is described by presence information. Such presence information may be made available to other users who may wish to communicate with the user currently present on the network. Current approaches of collecting, disseminating, and modifying presence information, however, are limited to either session initiation protocol (‘SIP’) style interactions or Simple Object Access Protocol (‘SOAP’) Web Services interactions whose interfaces are defined in a Web Service Description Language (‘WSDL’) document. Session initiation protocol (‘SIP’) style interactions require creation of a session which is often cumbersome in highly scalable Internet-based interactions. Web services interactions require a determination of an appropriate level of abstraction and standardization of interface techniques, which can also be cumbersome in larger networks with many disparate clients.

One particular method of disseminating presence information includes administering presence information in a web syndication feed, such as a Really Simple Syndication (‘RSS’) or Atom feed. Currently, however, administering such a feed of presence information is typically carried out through the cumbersome techniques described above, not through a loosely coupled network architecture style such as the Representational State Transfer (‘REST’) network architecture style.

### SUMMARY OF THE INVENTION

Methods, apparatus, and products for administering feeds of presence information of one or more presentities are described that include creating a feed definition; adding to the feed definition one or more identifications of presentities; receiving a feed request; creating the feed, the feed including presence information for presentities identified in the feed definition; and sending a response to the feed request including the feed.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for administering feeds of presence information of one or more presentities according to embodiments of the present invention.

FIG. 2 sets forth a block diagram of automated computing machinery comprising an exemplary computer useful in administering feeds of presence information of one or more presentities according to embodiments of the present invention.

FIG. 3 sets forth a flow chart illustrating an exemplary method for administering feeds of presence information of one or more presentities according to embodiments of the present invention.

FIG. 4 sets forth a flow chart illustrating a further exemplary method for administering feeds of presence information of one or more presentities according to embodiments of the present invention.

FIG. 5 sets forth a flow chart illustrating a further exemplary method for administering feeds of presence information of one or more presentities according to embodiments of the present invention.

### DETAILED DESCRIPTION OF EXEMPLARY EMBODIMENTS

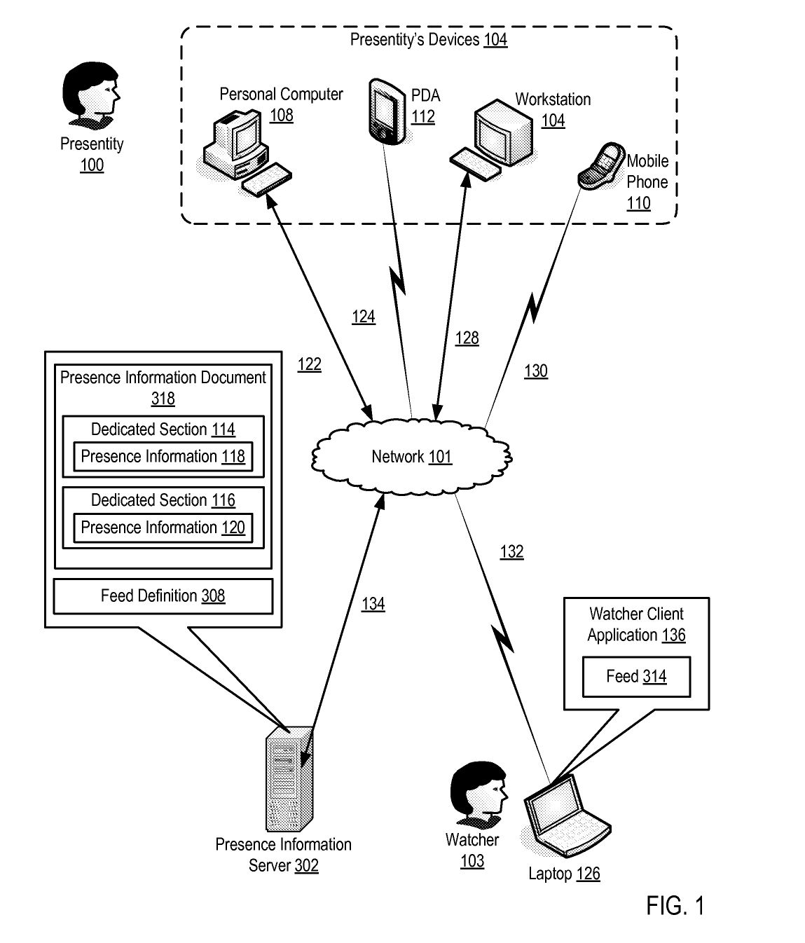

Exemplary methods, apparatus, and products for administering feeds of presence information of one or more presentities in accordance with the present invention are described with reference to the accompanying drawings, beginning with FIG. 1. FIG. 1 sets forth a network diagram of a system for administering feeds of presence information of one or more presentities according to embodiments of the present invention. The presentity (100) of FIG. 1 represents a user of the network (101). Presentities may communicate through the network (101) by using any number of devices. The presentity (100) of FIG. 1, for example, communicates through the network (101) by using such devices (104) as:
a personal computer (108) which is coupled for data communications to the network (101) through wireline connection (122);
a personal digital assistant (‘PDA’) (112) which is coupled for data communications to the network (101) by wireless connection (124);
a workstation (104) which is coupled for data communications to the network (101) by wireline connection (128); and
a mobile phone (110) which is coupled for data communications to the network (101) by wireless connection (130).

A presentity (100) is described by presence information (118, 120) contained in a presence information document. Presence information, in computer and telecommunications networks, is a status indicator that conveys to a watcher the availability and willingness of a presentity to communicate with other network users. Presence information may, for example, indicate the status of a user of an instant messaging client as “away,” “busy,” or “idle.” Presence information may change from time to time when a presentity's availability to communicate to other network users through any device changes.

The presence information of a presentity may correspond to any of the presentity's devices (104). For example, presence information corresponding to the presentity's (100) personal computer (108) may describe the status of the personal computer as ‘closed’ while presence information corresponding to the presentity's (100) work station (104) may describe the status of the work station as ‘open.’ Such presence information of the presentity, when taken as a whole, represents that the presentity is at work, away from the presentity's personal computer, but capable of communicating through the presentity's workstation.

Presence information is stored in a presence information server (302). The exemplary presence information server of FIG. 1 is a computer, or other automated computing machinery, capable of administering and storing presence information documents as well as administering and storing feeds of presence information of one or more presentities. A presence information server may store many presence information documents, each presence information document associated with a different presentity. That is, any number of users of the network (101) may provide their own presence information to watchers through the presence information server. The presence information server (302) is coupled for data communications to the network through wireline connection (134) and includes presence information of a presentity (100) in presence information document (318).

A presence information document may be a document that includes presence information for a presentity. The exemplary presence information document (318) of FIG. 1 is implemented as a markup document that includes one or more dedicated sections (114,116) for presence information (118,120) for the presentity (100). Each dedicated section (114,116) in a presence information document may include presence information corresponding to one of the presentity's devices (104). For example, one dedicated section may include presence information corresponding to the presentity's PDA (112), while another dedicated section includes presence information corresponding to the presentity's mobile phone (110).

Consider for further explanation the following exemplary presence information document implemented as an extensible markup language (‘XML’) markup document:

```
<?xml version=“1.0” encoding=“UTF-8”?>
<presence entity=“Brandon”>
    <note>Out of Office. Call my cell.</note>
<tuple id=“MyCellPhone”>
    <status>
        <basic>open</basic>
    </status>
    <contact>555-555-5555</contact>
</tuple>
<tuple id=”MyWorkEmail”>
    <status>
        <basic>closed</basic>
    </status>
    <contact>mailto:brandon@example.com</contact>
</tuple>
</presence>
```

In the XML example above, the presence information document includes a <presence entity> tag that identifies the user represented by the presentity. The presentity in the example above is identified as “Brandon.”

Also in the XML example above, the presence information document includes a <note> tag identifying text that the presentity, Brandon, intends for watchers of the Brandon's presence information to read. In this example, the note represents that Brandon is out of the office and can be reached on his cell phone.

Also in the XML example above, the presence information document includes two <tuple> tags, each tag identifying presence information for one of Brandon's networked devices. In this example, the <tuple> tag, <tuple id=“MyCellPhone”>, identifies presence information corresponding to Brandon's cell phone. The <tuple> tag, <tuple id=“MyWorkEmail”>, identifies presence information corresponding to Brandon's work email address.

Also in the XML example above, each <tuple> tag includes a dedicated section, identified by the <status> tag, describing the status of a device and contact information of the device. In this example, the <status> tag for Brandon's Cell phone identifies the status of the cell phone as “open.” Also in this example, the <status> tag for Brandon's work email describes the status of Brandon's work email as closed.

Also in the XML example above, each <tuple> tag also includes a <contact> tag, identifying the contact information corresponding to a device. In this example, the <contact> tag corresponding to Brandon's cell phone identifies a phone number, 555-555-5555, as contact information for the cell phone. Also in this example, the <contact> tag corresponding to Brandon's work email identifies an email address, brandon@example.com, as contact information for the cell phone.

In the system of FIG. 1 presence information is conveyed to a watcher (103) through the network (101) in a feed (314). A watcher is a user of the network that observes the presence information of a presentity. The watcher observes presence information of the presentity (101) by using a watcher client application, a module of computer program instructions that enables a watcher (103) to retrieve from a presence information server a feed of presence information of one or more presentities. In the example of FIG. 1, the watcher (103) observes the presence information of the presentity (100) through the watcher client application (136) running on the laptop (126) which is coupled for data communications to the network (101) through wireless connection (132).

The system of FIG. 1 is capable of administering feeds of presence information of one or more presentities through the network (101) according to a loosely-coupled network architecture style, such as for example, the REST network architecture style. The term ‘REST’ is a term used to describe an architecture style of networked systems. REST is an acronym standing for Representational State Transfer. A REST network architecture is typically characterized by:
A client-server, pull-based interaction style in which clients pull representations of resources from servers.
A uniform resource interface that provides access to all resources using a generic interface, such as for example, through HyperText Transfer Protocol (‘HTTP’) GET, POST, PUT, and DELETE requests.
Resources in the networked system which are named using a URI. URIs within REST may be constructed in such a manner as to navigate, or index into structured representations of resource entities
Representations of resources that are interconnected using URIs.
Layered components such as proxy servers, cache servers, gateways, and others, that can be inserted between clients and resources to support performance and security.

As mentioned above, the system of FIG. 1 operates generally for administering feeds of presence information of one or more presentities according to embodiments of the present invention. The system of FIG. 1 is capable of creating, by a presence information server (302) in response to a create request from a watcher client application (136), a feed definition (308) including a feed identification; adding, by the presence information server (302) in response to an add request from the watcher client application (136), to the feed definition (308) one or more identifications of presentities; receiving, by the presence information server (302) from the watcher client application (136), a feed request requesting a feed created from the feed definition (308), the feed request including the feed identification; creating, by the presence information server (302) in response to the feed request, the feed, the feed (314) including presence information for presentities identified in the feed definition; and sending, from the presence information server (302) to the watcher client application (136), a response to the feed request including the feed (314).

A feed is typically a markup document, such as an extensible markup language (‘XML’) document, that is used to serve frequently updated content. A feed may be updated from time to time to reflect such frequently updated content. A feed may be distributed to any number of users. News websites and weblogs (‘blogs’) are common sources for web feeds, but feeds are also used to deliver other structured information ranging from weather data to search results. When the information represented in a feed varies at the source of the information the feed is updated to reflect the new information. Consider as an example a news website that publishes a feed that contains articles from news website. When the news website adds a new article to the site, the feed is updated to reflect the new article.

Consider for further explanation the following exemplary feed that includes presence information of a presentity implemented as an extensible markup language (‘XML’) markup document:

```
<?xml version=“1.0” encoding=“utf-8”?>
<feed>
    <title>Bob's Watcher Feed For Brandon's Presence Info</title>
    <author>
        <name>Bob</name>
    </author>
    <id> myfeed </id>
    <entry>
        <title>Brandon's Cell Phone</title>
        <id>/Brandon/MyCellPhone/status/basic </id>
        <summary>open</summary>
    </entry>
</feed>
```

In the example above, the watcher feed includes a <title> tag identifying the subject matter represented by the feed. In this example the subject matter represented by the feed is “Bob's Watcher Feed For Brandon's Presence Info.” That is, Bob, a watcher uses the feed above to observe presence information of a presentity named Brandon. Also in the example above, the watcher feed includes an <id> tag that includes an identification of the feed itself. In the example above the <id> tag includes as the feed identification myfeed.

Also in the example above, the watcher feed includes an <entry> tag identifying an entry in the feed representing presence information of a presentity. In this example the <entry> tag includes presence information of Brandon's cell phone, as identified by the <title> tag. The entry also includes an <id> tag identifying the location of presence information of Brandon's cell phone. In this example the <id> tag identifies as the location of the presence information of Brandon's cell phone, the URI, /Brandon/MyCellPhone/status/basic. The entry also includes a <summary> tag identifying the presence information at the location identified by the <id> tag. In this example the summary tag identifies the presence information at the location identified by the <id> tag as ‘open.’

Although the example XML feed above includes only one entry representing presence information for one presentity, readers of skill in the art will immediately recognize that feeds of presence information according to embodiments of the present invention may include multiple entries for multiple presentities. In addition, more or less information may be present in each entry. In many feeds for example a timestamp is also included to identify the time that presence information was last updated by the presentity.

In the system of FIG. 1 creating, by a presence information server (302) in response to a create request from a watcher client application (136), a feed definition (308) including a feed identification is carried out by receiving an HTTP request message from a watcher client application (136), the HTTP request message including a feed identification, and creating a data structure identifying the feed. The feed identification included in an HTTP request message, a create request, may be part of a uniform resource identifier (‘URI’). Such URIs may also specify, in addition to the feed identification, data storage designated for storing feed definitions in the presence information server.

The presence information server parses the URI, determines the identification of the feed, determines the data storage designated for storing feed definitions, and creates a data structure identifying the feed in the data storage designated for storing feed definitions. When a presence information server receives the HTTP PUT request message, HTTP PUT/watchers/myfeed, for example, the presence information server parses the URI, determines the identification of the feed to be ‘myfeed,’ determines the data storage designated for storing feed definitions to be ‘watchers,’ and creates a data structure identifying the feed in the data storage designated for storing feed definitions. The data structure may be any type of data structure, such as, for example, a table in a database, a markup document, a file in a directory in file system, or others as will occur to those of skill in the art. Although the create request is described here as an HTTP PUT request message, readers of skill in the art will recognize that presence information servers according to embodiments of the present invention may be configured to create a feed definition in response to any type of HTTP request message, such as for example, an HTTP POST request message.

In the system of FIG. 1 adding, by the presence information server (302) in response to an add request from the watcher client application (136), to the feed definition (308) one or more identifications of presentities is carried out by receiving an HTTP request message from the watcher client application (136), the HTTP request message including one or more identifications of presentities, and adding to the data structure identifying the feed the one or more identifications of the presentities. The identification of a presentity included in an HTTP request message, an add request, may be part of a uniform resource identifier (‘URI’). In addition to an identification of a presentity, such URIs may also specify data storage designated for storing feed definitions in the presence information server and the feed identification.

The presence information server parses the URI to locate the feed definition and adds to the feed definition, the identification of the presentity in the URI. When a presence information server receives the HTTP POST request message, HTTP POST/watchers/myfeed/Bob, for example, the presence information server parses the URI, determines the identification of the presentity to be Bob, the identification of the feed corresponding to a data structure to be myfeed, and the identification of the data storage designated for storing feed definitions to be watchers.

Adding to the data structure identifying the feed the one or more identifications of the presentities is carried out in dependence upon the implementation of the data structure. If the data structure is implemented as a table in a database, for example, the presence information server may add an identification of a presentity by inserting the identification in an entry in the table. If the data structure is implemented as a markup document, as another example, the presence server may add an identification of a presentity by inserting the identification in the markup document as an attribute of a markup tag. If the data structure is implemented as a file in a directory in a file system, as yet another example, the presence information server may add an identification of a presentity by inserting the identification in the file.

The system of FIG. 1 also operates for administering feeds of presence information of one or more presentities according to embodiments of the present invention by monitoring, by the presence information server (302), presentities identified in the feed definition and maintaining presence information for the presentities in one or more presence information documents. As mentioned above, presence information for a presentity is stored in a presence information document on the presence information server. In the system of FIG. 1, the presence information of the presentities identified in the feed definition is administered by the presence information server (302), such that the presence information of the presentities identified in the feed definition is available to be inserted into a feed.

In the system of FIG. 1 receiving, by the presence information server (302) from the watcher client application (136), a feed request requesting a feed created from the feed definition (308) is carried out by receiving an HTTP message request that includes an identification of the feed. The HTTP message request, the feed request, may include a URI including the identification of the feed, as well as the data storage designated for storing feed definitions.

The presence information server parses the URI and determines the feed identification and the data storage designated for storing feed definitions. The presence information server uses the feed identification and data storage designated for storing feed definition to locate the feed definition that includes the feed identification. When the presence information server receives the HTTP GET request message, HTTP GET/watchers/myfeed, for example, the presence information server parses the URI and determines the feed identification to be ‘myfeed’ and the data storage designated for storing feed definitions to be ‘watchers’. The presence information server uses the feed identification and data storage designated for storing feed definitions to locate, in ‘watchers,’ the feed definition that includes the feed identification ‘myfeed’.

In the system of FIG. 1 creating, by the presence information server (302) in response to the feed request, the feed, the feed (314) including presence information for presentities identified in the feed definition is carried out by creating a markup document, retrieving from a presence information document presence information for the presentities identified in the feed definition, and inserting the retrieved presence information into the markup document.

Over time, a watcher client application may request many feeds created from the same feed definition in order to retrieve the current presence information of presentities identified in the feed definition. In some cases, however, the current presence information of a presentity identified in the feed definition has not changed since the last time a feed was created using the feed definition. A feed of presence information then may be configured in various ways. A feed of presence information may, for example, include all current presence information for presentities identified in the feed definition or, as an alternative, a feed of presence information may include only presence information for presentities identified in the feed definition that has changed since a previous feed. In this way, a feed may either be comprehensive, containing the most current presence information for all presentities identified in the feed definition, or lightweight, containing only presence information of presentities identified in the feed definition that has changed.

In the system of FIG. 1 sending, from the presence information server (302) to the watcher client application (136), a response to the feed request including the feed (314) is carried out by sending the feed in the message body of an HTTP response message. In response to an HTTP GET request message requesting the feed, the presence information server may send an HTTP response message that includes the feed in the message body of the response.

The system of FIG. 1 also operates for administering feeds of presence information of one or more presentities according to embodiments of the present invention by updating, by the presence information server, the feed definition. The presence server (302) may update the feed definition in various ways including receiving an HTTP request message from the watcher client application (136), the HTTP request message including one or more identifications of presentities, and deleting the one or more identifications of presentities. The HTTP request message may include a URI specifying one or more identifications of presentities, as well as the data storage designated for storing feed definitions and the identification of the feed. The presence information server parses the URI to determine the one or more identification of presentities, the data storage designated for storing feed definitions, and the identification of the feed. The presence information server then uses the parsed URI to locate the feed definition in data storage designated for storing feed definitions and deletes from the feed definition including the feed identification, the one or more identifications of presentities specified in the URI. In this way, a watcher may remove from any feed created from the feed definition, presence information corresponding to one or more particular presentities.

In addition to deleting one or more identifications of presentities from the feed definition, the presence server may also update the feed definition by receiving an HTTP request message from the watcher client application (136), the HTTP request message including one or more identifications of additional presentities, and adding the one or more identifications of additional presentities.

The arrangement of servers and other devices making up the exemplary system illustrated in FIG. 1 are for explanation, not for limitation. Data processing systems useful according to various embodiments of the present invention may include additional servers, routers, and other devices, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

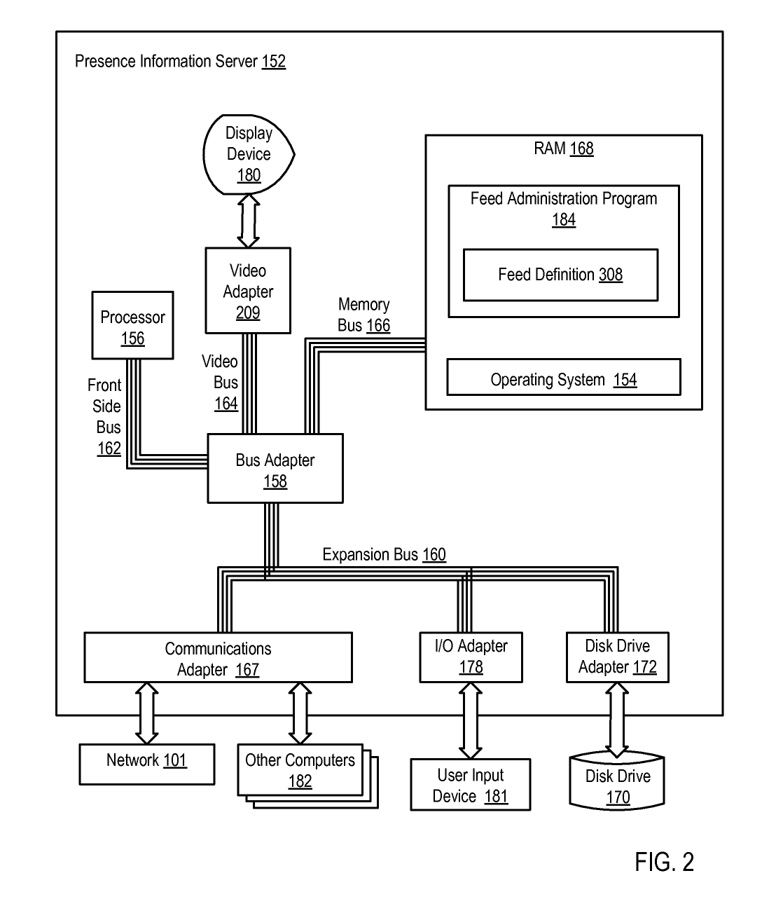

Administering feeds of presence information of one or more presentities in accordance with the present invention is generally implemented with computers, that is, with automated computing machinery. In the system of FIG. 1, for example, the devices (104) and presence information server (302) are implemented to some extent at least as computers. For further explanation, therefore, FIG. 2 sets forth a block diagram of automated computing machinery comprising an exemplary presence information server (152) useful in administering feeds of presence information of one or more presentities according to embodiments of the present invention. The presence information server (152) of FIG. 2 includes at least one computer processor (156) or ‘CPU’ as well as random access memory (168) (‘RAM’) which is connected through a high speed memory bus (166) and bus adapter (158) to processor (156) and to other components of the presence information server (152).

Stored in RAM (168) is a feed administration module (184), a module of computer program instructions for administering feeds of presence information of one or more presentities according to embodiments of the present invention. The feed administration module (184) is capable of creating, by a presence information server (152) in response to a create request from the watcher client application, a feed definition (308) including a feed identification; adding, by the presence information server (152) in response to an add request from the watcher client application, to the feed definition (308) one or more identifications of presentities; receiving, by the presence information server (152) from the watcher client application, a feed request requesting a feed created from the feed definition (308), the feed request including the feed identification; creating, by the presence information server (152) in response to the feed request, the feed, the feed including presence information for presentities identified in the feed definition; and sending, from the presence information server (152) to the watcher client application, a response to the feed request including the feed.

Also stored in RAM (168) is an operating system (154). Operating systems useful administering feeds of presence information of one or more presentities according to embodiments of the present invention include UNIX™, Linux™, Microsoft XP™, Microsoft Vista™, AIX™, IBM's i5/OS™, and others as will occur to those of skill in the art. The operating system (154), feed administration module (184), and feed definition (308), in the example of FIG. 2 are shown in RAM (168), but many components of such software typically are stored in non-volatile memory also, such as, for example, on a disk drive (170).

The presence information server (152) of FIG. 2 includes disk drive adapter (172) coupled through expansion bus (160) and bus adapter (158) to processor (156) and other components of the presence information server (152). Disk drive adapter (172) connects non-volatile data storage to the presence information server (152) in the form of disk drive (170). Disk drive adapters useful in presence information servers for administering feeds of presence information of one or more presentities according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example presence information server (152) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example presence information server (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary presence information server (152) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for administering feeds of presence information of one or more presentities according to embodiments of the present invention include modems for wired dial-up communications, Ethernet (IEEE 802.3) adapters for wired data communications network communications, and 802.11 adapters for wireless data communications network communications.

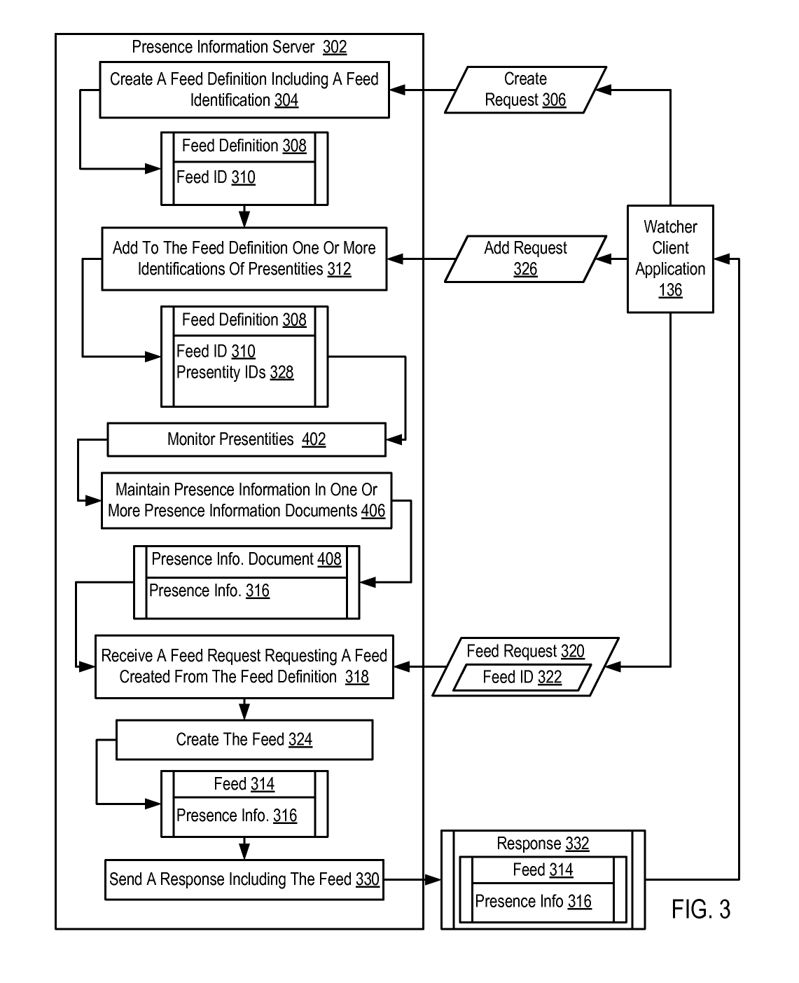

For further explanation, FIG. 3 sets forth a flow chart illustrating an exemplary method for administering feeds of presence information of one or more presentities according to embodiments of the present invention. The method of FIG. 3 includes creating (304), by a presence information server (302) in response to a create request (306) from a watcher client application (136), a feed definition (308) including a feed identification (310). Creating (304), by a presence information server (302) in response to a create request (306) from a watcher client application (136), a feed definition (308) including a feed identification (310) is carried out by receiving an HTTP request message from a watcher client application (136), the HTTP request message including a feed identification, and creating a data structure identifying the feed. The feed identification included in an HTTP request message, a create request, may be part of a uniform resource identifier (‘URI’). Such URIs may also specify, in addition to the feed identification, data storage designated for storing feed definitions in the presence information server. The presence information server parses the URI, determines the identification of the feed, determines the data storage designated for storing feed definitions, and creates a data structure identifying the feed in the data storage designated for storing feed definitions.

The method of FIG. 3 also includes adding (312), by the presence information server (302) in response to an add request (326) from the watcher client application (136), to the feed definition (308) one or more identifications of presentities (328). Adding (312), by the presence information server (302) in response to an add request (326) from the watcher client application (136), to the feed definition (308) one or more identifications of presentities (328) is carried out by receiving an HTTP request message from a watcher client application (136), the HTTP request message including one or more identifications of presentities, and adding to the data structure identifying the feed the one or more identifications of the presentities.

The method of FIG. 3 also includes monitoring (402), by the presence information server (302), presentities identified in the feed definition (308), and maintaining (406) presence information (316) for the presentities in one or more presence information documents (408). Monitoring (402) presentities identified in the feed definition (308) and maintaining (406) presence information (316) for the presentities in one or more presence information documents (408) is carried out by receiving requests from presentities to update their presence information and, in response to the requests, updating the presence information documents corresponding the presentities. The presence information server updates the presence information documents, such that, presence information in the presence information documents is available to insert into a feed.

The method of FIG. 3 also includes receiving (318), by the presence information server (302) from the watcher client application (136), a feed request (310) requesting a feed (314) created from the feed definition (308), the feed request (320) including the feed identification (310). Receiving (318), by the presence information server (302) from the watcher client application (136), a feed request (310) requesting a feed (314) created from the feed definition (308) is carried out by receiving an HTTP message request that includes an identification of the feed. The HTTP message request, the feed request, may include a URI including the identification of the feed, as well as the data storage designated for storing feed definitions. The presence information server parses the URI and determines the feed identification and the data storage designated for storing feed definitions. The presence information server uses the feed identification and data storage designated for storing feed definition to locate the feed definition that includes the feed identification.

The method of FIG. 3 also includes creating (324), by the presence information server (302) in response to the feed request (320), the feed, the feed (314) including presence information (316) for presentities identified in the feed definition (308). Creating (324) the feed (314) may be carried out by creating a markup document, retrieving from a presence information document presence information for the presentities identified in the feed definition, and inserting the retrieved presence information into the markup document.

As mentioned above, over time a watcher client application (136) may request many feeds created from the same feed definition in order to retrieve the current presence information of presentities identified in the feed definition. In some cases, however, the current presence information of a presentity identified in the feed definition has not changed since the last time a feed was created using the feed definition. A feed of presence information then may be configured in various ways. A feed of presence information may, for example, include all current presence information for presentities identified in the feed definition or, as an alternative, a feed of presence information may include only presence information for presentities identified in the feed definition that has changed since a previous feed. In this way a feed may either be comprehensive, containing the most current presence information for all presentities identified in the feed definition, or lightweight, containing only presence information of presentities identified in the feed definition that has changed.

The method of FIG. 3 also includes sending (330), from the presence information server (302) to the watcher client application (136), a response (332) to the feed request (320) including the feed (314). Sending (320) a response (332) including the feed (314) may be carried out by sending the feed in the message body of an HTTP response message. In response to an HTTP GET request message requesting the feed, the presence information server may send an HTTP response message that includes the feed in the message body of the response.

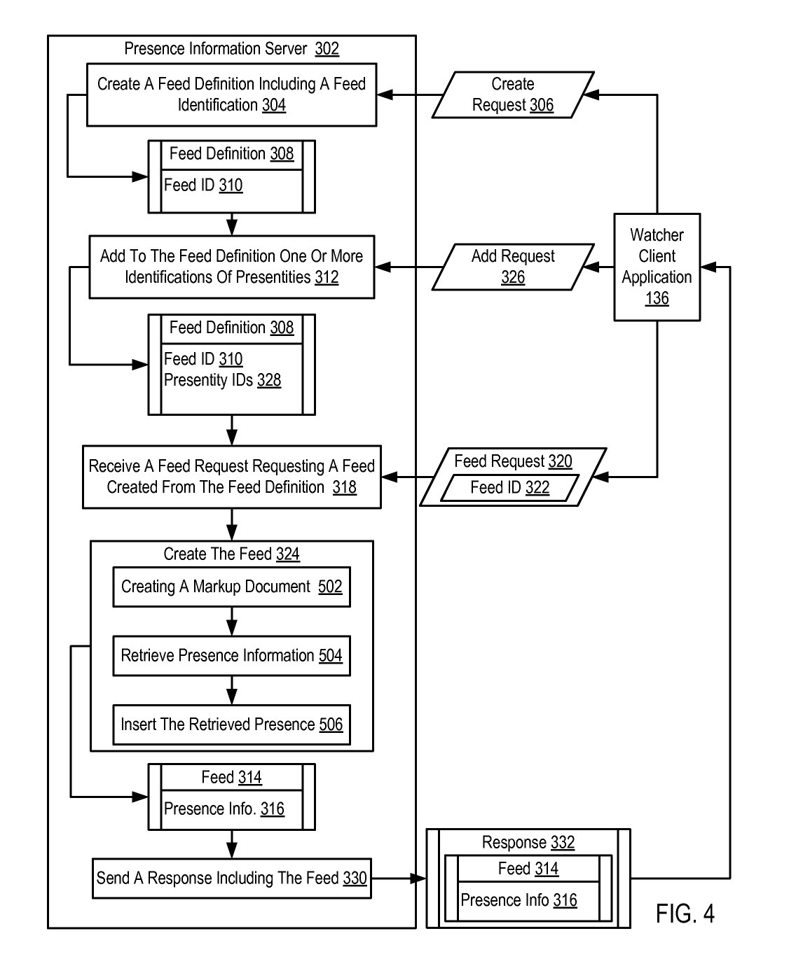

For further explanation, FIG. 4 sets forth a flow chart illustrating a further exemplary method for administering feeds of presence information of one or more presentities according to embodiments of the present invention. The method of FIG. 4 is similar to the method of FIG. 3 in that the method of FIG. 4 also includes creating (304) a feed definition (308) including a feed identification (310); adding (312) to the feed definition (308) one or more identifications of presentities (328); receiving (318) a feed request (310); creating (324) the feed; and sending (330) a response (332) to the feed request (320) including the feed (314).

The method of FIG. 4 differs from the method of FIG. 3, however, in that, in the method of FIG. 4, creating (324) the feed (314) is carried out by creating (502) a markup document, retrieving (504), from one or more presence information documents, presence information (316) for the presentities identified in the feed definition (308), and inserting (506) the retrieved presence information (316) into the markup document. The markup document may be any type of markup document such as the exemplary XML feed described above. The presence information inserted into the markup document may be inserted as an entry identified by a tag element designated for that purpose.

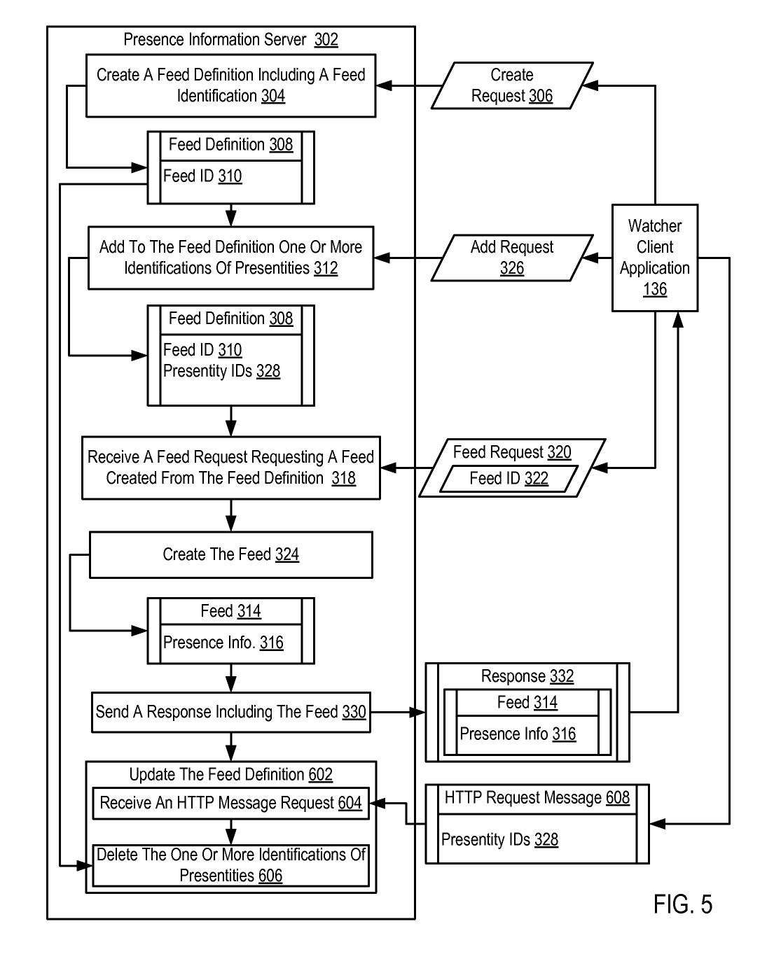

For further explanation, FIG. 5 sets forth a flow chart illustrating a further exemplary method for administering feeds of presence information of one or more presentities according to embodiments of the present invention. The method of FIG. 5 is similar to the method of FIG. 3 in that the method of FIG. 5 also includes creating (304) a feed definition (308) including a feed identification (310); adding (312) to the feed definition (308) one or more identifications of presentities (328); receiving (318) a feed request (310); creating (324) the feed; and sending (330) a response (332) to the feed request (320) including the feed (314).

The method of FIG. 5 differs from the method of FIG. 3, however, in that the method of FIG. 5 includes updating (602) the feed definition (308). In the method of FIG. 5, updating (602) the feed definition (308) is carried out by receiving (604) an HTTP request message (608) from the watcher client application (136), the HTTP request message (608) including one or more identifications of presentities (328), and deleting (606) the one or more identifications of presentities (328) from the feed definition (308).

The HTTP request message (608) may include a URI specifying an identification of a presentity (328), as well as the data storage designated for storing feed definitions and the identification (310) of the feed. The presence information server (302) parses the URI to determine the identification (328) of the presentity, the data storage designated for storing feed definitions, and the identification (328) of the feed. The presence information server then uses the parsed URI to locate the feed definition in data storage designated for storing feed definitions and deletes from the feed definition that includes the feed identification (310), the identification (328) of the presentity specified in the URI. In this way, a watcher may remove from any feed created from the feed definition, presence information corresponding to one or more particular presentities.

In addition to deleting one or more identifications of presentities from the feed definition, the presence server may also update the feed definition by receiving an HTTP request message from a watcher client application (136), the HTTP request message including one or more identifications of additional presentities, and adding the one or more identifications of additional presentities. That is, the feed definition may be updated either by adding or deleting presentity identifications.

Exemplary embodiments of the present invention are described largely in the context of a fully functional computer system for administering feeds of presence information of one or more presentities. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for administering feeds of presence information of one or more presentities through a network according to a loosely-coupled network architecture style, each presentity representing a user of the network, the method comprising:
creating, by a presence information server in response to a create request from a watcher client application, a feed definition including a feed identification;
adding, by the presence information server in response to an add request from the watcher client application, to the feed definition one or more identifications of presentities;
receiving, by the presence information server from the watcher client application, a feed request requesting a feed created from the feed definition, the feed request including the feed identification;
creating, by the presence information server in response to the feed request, the feed, the feed including presence information for presentities identified in the feed definition; and
sending, from the presence information server to the watcher client application, a response to the feed request including the feed.

2. The method of claim 1 wherein the presence information in the feed includes all current presence information for presentities identified in the feed definition.

3. The method of claim 1 wherein the presence information in the feed includes presence information for presentities identified in the feed definition that has changed since a previous feed.

4. The method of claim 1 further comprising:
monitoring, by the presence information server, presentities identified in the feed definition; and
maintaining presence information for the presentities in one or more presence information documents.

5. The method of claim 1 wherein creating, by a presence information server in response to a create request from a watcher client application, a feed definition further comprises:
receiving a Hypertext Transfer Protocol (‘HTTP’) request message from the watcher client application, the HTTP request message including a feed identification; and
creating a data structure identifying the feed.

6. The method of claim 3 wherein adding, by the presence information server in response to an add request from the watcher client application, to the feed definition one or more identifications of presentities further comprises:
receiving an HTTP request message from the watcher client application, the HTTP request message including one or more identifications of presentities; and
adding to the data structure identifying the feed the one or more identifications of the presentities.

7. The method of claim 1 wherein creating, in response to the feed request by the presence information server, the feed further comprises:
creating a markup document;
retrieving, from one or more presence information documents, presence information for the presentities identified in the feed definition; and
inserting the retrieved presence information into the markup document.

8. The method of claim 1 further comprising updating the feed definition including:
receiving an HTTP request message from the watcher client application, the HTTP request message including one or more identifications of presentities; and
deleting the one or more identifications of presentities from the feed definition.

9. An apparatus for administering feeds of presence information of one or more presentities through a network according to a loosely-coupled network architecture style, each presentity representing a user of the network, the apparatus comprising a computer processor, a computer memory operatively coupled to the computer processor, the computer memory having disposed within it computer program instructions capable of:
creating, by a presence information server in response to a create request from the watcher client application, a feed definition including a feed identification;
adding, by the presence information server in response to an add request from the watcher client application, to the feed definition one or more identifications of presentities;
receiving, by the presence information server from the watcher client application, a feed request requesting a feed created from the feed definition, the feed request including the feed identification;
creating, by the presence information server in response to the feed request, the feed, the feed including presence information for presentities identified in the feed definition; and
sending, from the presence information server to the watcher client application, a response to the feed request including the feed.

10. The apparatus of claim 9 wherein the presence information in the feed includes all current presence information for presentities identified in the feed definition.

11. The apparatus of claim 9 wherein the presence information in the feed includes presence information for presentities identified in the feed definition that has changed since a previous feed.

12. The apparatus of claim 9 wherein creating, by a presence information server in response to a create request from a watcher client application, a feed definition further comprises:
receiving a Hypertext Transfer Protocol (‘HTTP’) request message from the watcher client application, the HTTP request message including a feed identification; and
creating a data structure identifying the feed.

13. The apparatus of claim 9 wherein adding, by the presence information server in response to an add request from the watcher client application, to the feed definition one or more identifications of presentities further comprises:
receiving an HTTP request message from the watcher client application, the HTTP request message including one or more identifications of presentities; and
adding to the data structure identifying the feed the one or more identifications of the presentities.

14. The apparatus of claim 9 further comprising computer program instructions capable of updating the feed definition including:
receiving an HTTP request message from the watcher client application, the HTTP request message including one or more identifications of presentities; and
deleting the one or more identifications of presentities from the feed definition.

15. A computer program product for administering feeds of presence information of one or more presentities through a network according to a loosely-coupled network architecture style, each presentity representing a user of the network, the computer program product disposed in a computer readable, signal bearing medium, the computer program product comprising computer program instructions capable of:
creating, by a presence information server in response to a create request from the watcher client application, a feed definition including a feed identification;
adding, by the presence information server in response to an add request from the watcher client application, to the feed definition one or more identifications of presentities;
receiving, by the presence information server from the watcher client application, a feed request requesting a feed created from the feed definition, the feed request including the feed identification;
creating, by the presence information server in response to the feed request, the feed, the feed including presence information for presentities identified in the feed definition; and
sending, from the presence information server to the watcher client application, a response to the feed request including the feed.

16. The computer program product of claim 15 wherein the presence information in the feed includes all current presence information for presentities identified in the feed definition.

17. The computer program product of claim 15 wherein the presence information in the feed includes presence information for presentities identified in the feed definition that has changed since a previous feed.

18. The computer program product of claim 15 wherein creating, by a presence information server in response to a create request from a watcher client application, a feed definition further comprises:
receiving a Hypertext Transfer Protocol (‘HTTP’) request message from the watcher client application, the HTTP request message including a feed identification; and
creating a data structure identifying the feed.

19. The computer program product of claim 18 wherein adding, by the presence information server in response to an add request from the watcher client application, to the feed definition one or more identifications of presentities further comprises:
receiving an HTTP request message from the watcher client application, the HTTP request message including one or more identifications of presentities; and
adding to the data structure identifying the feed the one or more identifications of the presentities.

20. The computer program product of claim 15 further comprising computer program instructions capable of updating the feed definition including:
receiving an HTTP request message from the watcher client application, the HTTP request message including one or more identifications of presentities; and
deleting the one or more identifications of presentities from the feed definition.
